(19) United States
(12) Patent Application Publication
(10) Pub. No.: US 2005/0284673 A1
(43) Pub. Date: Dec. 29, 2005

(54) Power source device for a vehicle

(76) Inventors: Yosuke Nakazawa, Tokyo (JP); Hiroshi Mochikawa, Tokyo (JP); Hirotada Kira, Tokyo (JP); Michiaki Ishikawa, Saitama-ken (JP); Takuma Hemmi, Kanagawa-ken (JP); Mika Hemmi, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/147,216

(22) Filed: Jun. 8, 2005

(30) Foreign Application Priority Data
Jun. 8, 2004 (JP) 2004-169330
Apr. 20, 2005 (JP) 2005-122787

(51) Int. Cl. H02M 7/48

(52) U.S. Cl. 180/65.1; 363/71

(57) ABSTRACT

A vehicle power source device is provided with an DC/DC converter (4) having a high-frequency insulating transformer (6) that converts power from an overhead power line to DC power, and a CVCF inverter (1) that converts the DC power supplied from this DC/DC converter (4) to AC power; the AC power converted by this CVCF inverter (1) is supplied to equipment such as for on-board lighting.

### CROSS-REFERENCE TO RELATED APPLICATION

This application claims benefit of priority from Japanese application numbers JP 2004-169330 filed Jun. 8, 2004 and JP 2005-122787 filed Apr. 20, 2005, the entire contents of which are incorporated by reference herein.

### BACKGROUND OF THE INVENTION

1. Field of the Invention

The present invention relates to a power source device for a vehicle.

2. Description of the Related Art

Typically, in a rail vehicle, there are mounted a main conversion device for supplying AC power to an electric motor and a vehicle power source device for supplying AC power to lighting and/or air-conditioning devices within the vehicle.

A conventional vehicle power source device is described with reference to the drawings. FIG. 1 is a layout diagram of a conventional vehicle power source device.

A conventional vehicle power source device comprises a CVCF (Constant Voltage Constant Frequency) inverter 1, LC (Inductance-Capacitance Filter) filter 2, and insulating transformer 3. The CVCF inverter 1 converts power from the overhead power line (feeder or electric supply line) to three-phase 60 Hz 440V AC power and supplies this AC power to the LC filter 2. The LC filter 2 removes the PWM (Pulse Width Modulation) harmonics of the three-phase AC power converted by the CVCF inverter 1 and supplies low-distortion three-phase AC power to the vehicle lighting equipment and/or air-conditioner through the insulating transformer 3. The insulating transformer 3 is provided in order to prevent damage to the equipment by direct propagation to equipment such as on-board lighting of lightning surges on the overhead power line.

Such vehicle power source devices constructed in this way are capable of supplying power to equipment such as on-board lighting while preventing direct propagation of lightning surges to equipment such as on-board lighting. An example of such a vehicle power source device is disclosed in Laid-open Japanese Patent Application No. (Tokkai 2003-47245)

However, for the insulating transformer 3, a core such as to ensure ample magnetic flux density is employed so that magnetic saturation of the core does not occur at the low frequency of 60 Hz and this core is thus of considerable weight and volume. Weight reduction and size reduction are particularly demanded in respect of equipment for rail vehicles, so there is room for improvement in this respect.

### SUMMARY OF THE INVENTION

Accordingly, one object of the present invention is to provide a novel power source device for a vehicle whereby size reduction can be achieved.

The above object can be achieved by the following construction of the present invention. Specifically, this can be achieved by providing: an inverter that converts DC power to high frequency AC power; a high frequency transformer whereby the AC power that is supplied from this inverter is electrically insulated; a plurality of unit DC/DC converters of miniature unitary construction whose unit modules are rectifiers that convert the high frequency AC power supplied from this high frequency transformer to DC power; and a CVCF inverter that converts the DC power supplied from these DC/DC converters to AC power; wherein the input sides of said plurality of unit DC/DC converters are connected in series and the output sides of said plurality of unit DC/DC converters are series or parallel or series/parallel connected.

Further, the above object can be achieved by providing: a plurality of unit DC/DC converters having a high frequency insulating transformer wherein the power of the overhead power line is converted to DC power by means of this plurality of unit DC/DC converters; and a CVCF inverter that converts the DC power supplied from these unit DC/DC converters to AC power.

Further, the above object can be achieved by providing: a DC/DC converter having a high frequency insulating transformer, that converts the power of the overhead power line to DC power; and a CVCF inverter that converts the DC power supplied from this DC/DC converter to AC power.

Further, the above object can be achieved by providing: a vehicle power source device comprising: an inverter that converts DC power to high frequency AC power; a high frequency transformer whereby the AC power that is supplied from said inverter is electrically insulated; a unit DC/DC converter of miniature unitary construction whose unit module is a rectifier that converts the high frequency AC power supplied from this high frequency transformer to DC power; a DC/AC converter that converts the DC power supplied from said plurality of unit DC/DC converters to AC power; and a plurality of unit converter units of unitary construction whose unit modules are said one unit DC/DC converter and said DC/AC converter, wherein the outputs of said plurality of unit converter units are connected in series and said plurality of unit converter units perform phase difference operation.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a layout diagram of a conventional vehicle power source device;

FIG. 2 is a layout diagram of a vehicle power source device according to a first embodiment of the present invention;

FIG. 3 is a layout diagram of a DC/DC converter shown in FIG. 1;

FIG. 4 is a layout diagram of a vehicle power source device according to a second embodiment of the present invention;

FIG. 5 is a layout diagram of a DC/DC converter of a vehicle power source device according to a second embodiment of the present invention;

FIG. 6 is a diagram of the switching action of the inverter;

FIG. 7 is a layout diagram of a vehicle power source device according to a third embodiment of the present invention;

FIG. 8 is a layout diagram of a DC/DC converter of a vehicle power source device according to a further modified example of the present invention;

FIG. 9 is a layout diagram of the case where the DC/DC converter according to the third embodiment of the present invention is arranged on a printed circuit board;

FIG. 10 is a layout diagram of a unit converter unit of a vehicle power source device according to a fourth embodiment of the present invention;

FIG. 11 is a layout diagram of a vehicle power source device according to the fourth embodiment of the present invention;

FIG. 12 is a diagram of the phase difference operation in a vehicle power source device according to the fourth embodiment of the present invention;

FIG. 13 is a diagram of the combined output voltage waveform in phase difference operation of a vehicle power source device according to the fourth embodiment of the present invention;

FIG. 14 is a layout diagram of a unit DC/DC converter of a vehicle power source device according to a fifth embodiment of the present invention;

FIG. 15 is a layout diagram of a vehicle power source device according to a sixth embodiment of the present invention;

FIG. 16 is a layout diagram of a vehicle power source device according to a seventh embodiment of the present invention; and

FIG. 17 is a modified example of a vehicle power source device according to the seventh embodiment of the present invention.

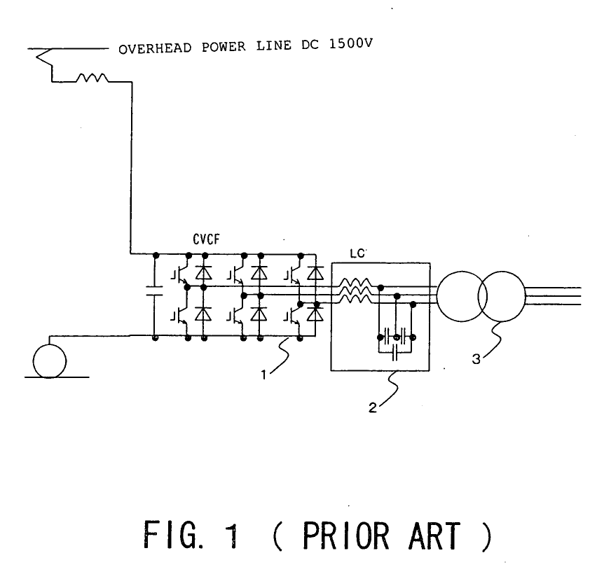

### DETAILED DESCRIPTION OF THE PREFERRED EMBODIMENTS

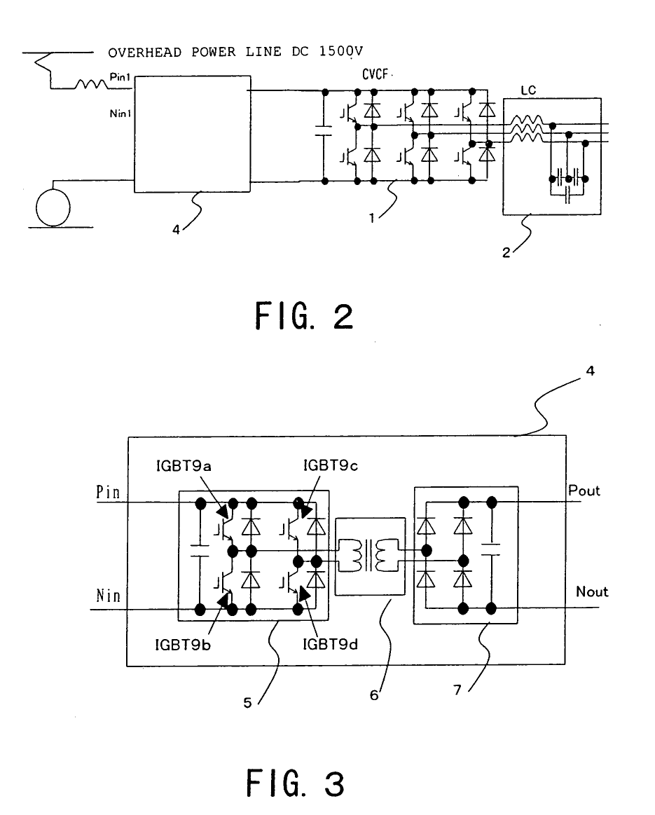

Referring now to the drawings, wherein like reference numerals designate identical or corresponding parts throughout the several views, and more particularly to FIG. 2 and FIG. 3 thereof, one embodiment of the present invention will be described.

### First Embodiment

A vehicle power source device according to a first embodiment of the present invention is described in detail with reference to the drawings. FIG. 2 is a layout diagram of a vehicle power source device according to a first embodiment of the present invention. FIG. 3 is a layout diagram of a DC/DC converter of a vehicle power source device according to the first embodiment of the present invention.

It is known that an insulating transformer 3 can typically be made lighter in weight and smaller in size as the frequency is increased. Accordingly, in the vehicle power source device according to the first embodiment of the present invention, as shown in FIG. 2 and FIG. 3, the overhead line power is temporarily converted by an inverter 5 within the DC/DC converter 4 into a high frequency such as 50 kHz and is then rectified by a rectifier 7 after insulation has been achieved by a high frequency transformer 6. The DC voltage rectified by the rectifier 7 is converted to three-phase AC by the CVCF inverter 1.

With a vehicle power source device constructed in this way, a high frequency insulating transformer can be employed, which can be made of small size, so the size of the vehicle power source device itself can also be reduced.

### Second Embodiment

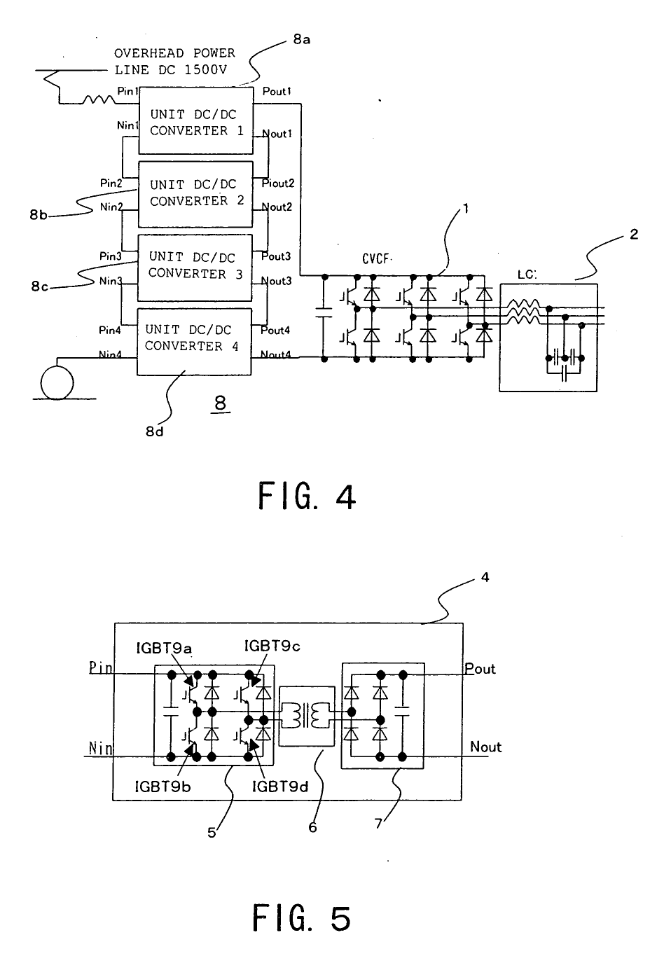

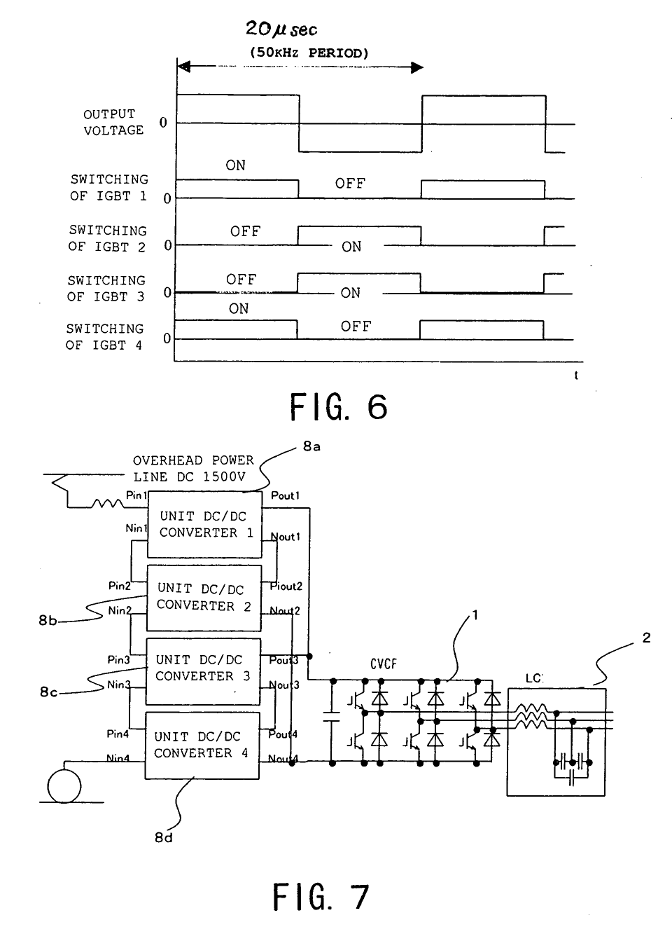

A second embodiment of a vehicle power source device according to the present invention is described in detail with reference to the drawings. FIG. 4 is a layout diagram of a vehicle power source device according to the second embodiment of the present invention. FIG. 5 is a layout diagram of a DC/DC converter of the vehicle power source device of the second embodiment of the present invention. FIG. 6 is a diagram of the switching action of the inverter. In the description, where it is necessary to distinguish identical parts, these are distinguished by adding a suffix after the numeral.

When a vehicle power source device according to the first embodiment of the present invention was actually manufactured employing a high frequency insulating transformer 3, it was found that it is necessary to lead out the high frequency, high-voltage high-power main circuit wiring into the housing of the DC/DC converter 4 and it was found that problems could arise due to generation of heat by inductive heating if care was not taken regarding the method of fixing the wiring cables to provide ample space between the housing and the wiring. In order to avoid problems regarding generation of heat by inductive heating, careful design of the wiring etc must be carried out on each occasion for each type of rail vehicle specification: this gives rise to concern in that it may cause increase in equipment design costs.

It was also found, with this vehicle power source device according to the first embodiment of the present invention, that use of semiconductor elements of high voltage withstanding ability capable of withstanding the overhead power line voltage was required for the DC/DC converter 4; these semiconductor elements of high voltage withstanding ability are operated at a high switching rate of for example 50 kHz, so it was found that the heat generation due to switching losses was considerable and the cooler (not shown) required to deal with this generation of heat had to be increased in size.

That is, when a high frequency insulating transformer 3 was employed on its own as in the case of the vehicle power source device of this first embodiment of the present invention, it was found that design costs were increased because of wiring problems, and a problem arose regarding increased size of the cooler due to the problem of generation of heat by the semiconductor elements, as a result of which it was not possible to implement a vehicle power source device employing the high frequency insulating transformer 3 practically.

In order to solve the problems of a vehicle power source device according to the first embodiment of the present invention, in a vehicle power source device according to a second embodiment of the present invention the DC/DC converter 4 is constructed of four identical unit DC/DC converters 8 (comprising an inverter 5, high frequency insulating transformer 6, and rectifier 7) of capacity about 10 KW and voltage withstanding ability 375V in unitized form, together with a CVCF inverter 1 and LC filter 2.

In a vehicle power source device constructed in this way, the positive input Pin1 of the first unit DC/DC converter 8a is connected with the overhead power line through a pantograph and DC reactor. The negative input Nin1 of the first unit DC/DC converter 8a is connected with the positive input Pin2 of a second unit DC/DC converter 8b. The negative input Nin2 of the second unit DC/DC converter 8b is connected with the positive input pin 3 of a third unit DC/DC converter 8c and the negative input Nin3 of the third unit DC/DC converter 8c is connected with the positive input Pin4 of a fourth unit DC/DC converter 8d. The negative input Nin4 of the fourth unit DC/DC converter 8d is connected with a vehicle wheel connected with the negative side of the overhead power line. The positive output Pout1 of the first DC/DC converter 8a is connected with the positive side of the CVCF inverter 1, and the negative output Nout1 of the first unit DC/DC converter 8a is connected with the positive output Pout2 of the second unit DC/DC converter 8b. The negative output Nout2 of the second unit DC/DC converter 8b is connected with the positive output Pout3 of the third unit DC/DC converter 8c and the negative output Nout3 of the third unit DC/DC converter 8c is connected with the positive output Pout4 of the fourth unit DC/DC converter 8d. The negative output Nout4 of the fourth unit DC/DC converter 8d is connected with the load of the CVCF inverter 1. An LC filter 2 is connected with the three-phase AC output of the CVCF inverter 1.

In a vehicle power source device constructed in this way, the four unit DC/DC converters 8 first of all convert the power supplied from the overhead power line to high frequency DC power before supplying it to the CVCF inverter 1. The CVCF inverter 1 converts the DC power supplied from the unit DC/DC converters 8 to AC power which is output to the LC filter 2. The LC filter 2 removes the PWM harmonics from the three-phase AC power that is converted by the CVCF inverter 1 to supply low-distortion three-phase AC power to the vehicle lighting equipment and/or air-conditioner.

In a vehicle power source device constructed in this way, the unit DC/DC converter 8 is integrally constituted, of the inverter 5, high frequency insulating transformer 6 and rectifier 7 as unit modules thereof. The inverter 5 in the unit DC/DC converter 8 converts the overhead line power that is supplied from the overhead power line to AC power of high frequency of 50 kHz. The high frequency insulating transformer 6 electrically insulates the 50 kHz AC power that is output from the inverter 5 before this AC power is supplied to the rectifier 7. The rectifier 7 rectifies the 50 kHz AC power to convert it to DC power, which is output.

The inverter 5 in the unit DC/DC converter 8 comprises IGBT elements IGBT 9a to IGBT 9d (an IGBT is a type of semiconductor element), and a DC capacitor 10. When DC power is supplied between the Pin and Nin of the unit DC/DC converter 8, it is smoothed by the DC capacitor 10 and high frequency AC power of 50 kHz produced by the switching action of the IGBTs 9a to 9d referred to above is then supplied to the high frequency insulating transformer 6. The IGBT 9a and IGBT 9b provided in the inverter 4 in the DC/DC converter 8 perform mutually inverted switching actions and, as shown in FIG. 6, are repeatedly turned on and off in each half cycle of time period 20 microseconds, corresponding to 50 kHz. The IGBT 9a is turned on in the initial half period (0 microseconds to 10 microseconds) and is turned off in the remaining half period (10 microseconds to 20 microseconds). Contrariwise, the IGBT 9b is turned off in the initial half period (0 microseconds to 10 microseconds) and is turned on in the remaining half period of (10 microseconds to 20 microseconds). The IGBT 9a and IGBT 9d and IGBT 9b and IGBT 9c respectively perform identical switching actions.

That is, when the IGBT 9a is on, the IGBT 9d is also on and when the IGBT 9a is off, the IGBT 9d is also off. When the IGBT 9b is on, the IGBT 9c is also on. When the IGBT 9d is off, the IGBT 9c is also off.

By this action of the inverter 5, 50 kHz square-wave AC voltage is output from the inverter 5.

In a vehicle power source device constructed in this way, in the rectifier 7 the 50 kHz AC power that is output from the high frequency insulating transformer 6 is rectified by a bridge arrangement of diode rectifiers; DC power is output after voltage smoothing using a smoothing capacitor 11 connected with the output stage.

In a vehicle power source device constructed in this way, the input side to the unit DC/DC converter 8 of the power from the overhead line is assumed to be connected in series, so there is no need for the switching elements 9 (9a, 9b, 9c, 9d) of the unit DC/DC converter 8 to have a high voltage withstanding ability capable of withstanding the voltage of the overhead power line, so elements of low voltage withstanding ability and low switching loss can be employed. With a vehicle power source device according to this embodiment, reduced loss can therefore be achieved.

Also, in a vehicle power source device according to this embodiment, by combining unit DC/DC converters 8 (8a, 8b, 8c, 8d) taking into account problems such as inductive heating, it is possible to create a vehicle power source device having any desired device capacity or output voltage, so, in addition to reduced loss, reduced costs can also be achieved. Furthermore, since, with a vehicle power source device according to this embodiment, it is possible to employ a high frequency insulating transformer 6 instead of the low frequency insulating transformer 3, a reduction in size can also be achieved.

Thus, with a vehicle power source device constructed in this way, cost reduction, reduced loss and size reduction can be achieved.

It should be noted that although, in the vehicle power source device according to the second embodiment of the present invention, the embodiment was described taking as an example AC power of 50 kHz, which has been found experimentally to be the frequency at which overall loss is smallest and is therefore most preferred, since in the vehicle power source device of this embodiment benefits of cost reduction, reduced loss and size reduction are obtained, other values than this AC frequency could of course be selected, so long as the AC power is of high frequency above 10 kHz.

### Third Embodiment

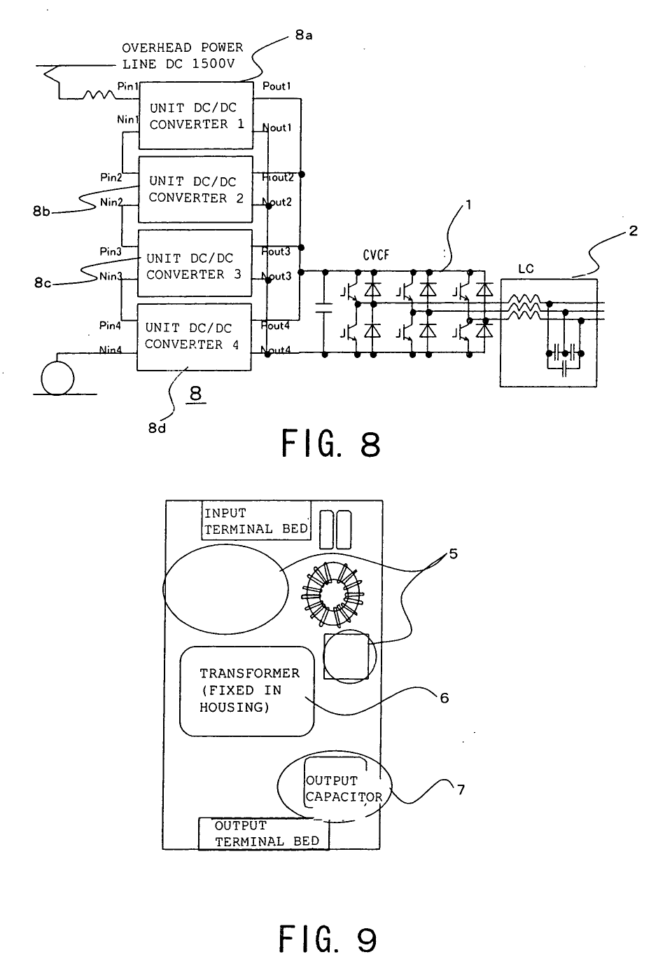

A vehicle power source device according to a third embodiment of the present invention is described in detail with reference to the drawings. FIG. 7 is a layout diagram of a vehicle power source device according to the third embodiment of the present invention. FIG. 8 is a layout diagram of a vehicle power source device according to another modified example of the present invention. FIG. 9 is a layout diagram of the case in which a DC/DC converter according to the third embodiment of the present invention is arranged on a printed circuit board. Parts which are structurally identical with those shown in FIG. 2 to FIG. 6 are given the same reference symbols and further description thereof is omitted.

In a vehicle power source device according to the third embodiment of the present invention, the DC output side of the first unit DC/DC converter 8a and the DC output side of the second DC/DC converter 8b are series-connected to constitute a first series circuit and the DC output side of the third unit DC/DC converter 8c and the DC output side of the fourth DC/DC converter 8b are connected in parallel with the series-connected second series circuit.

In a vehicle power source device constructed in this way, the positive output Pout1 of the first unit DC/DC converter 8a is connected with the positive side of the CVCF inverter 1. The negative output Nout1 of the first unit DC/DC converter 8a is connected with the positive output Pout2 of the second unit converter 8b. The negative output Nout2 of the second DC/DC converter 8b is connected with the negative side of the CVCF inverter 1. The positive output Pout3 of the third unit DC/DC converter 8c is connected with the positive side of the CVCF inverter 1. The negative output Nout3 of the third unit DC/DC converter 8c is connected with the positive output Pout4 of the fourth unit converter 8d. The negative output Nout4 of the fourth DC/DC converter 8d is connected with the negative side of the CVCF inverter 1.

The vehicle power source device shown in FIG. 7 constructed in this way is particularly beneficial in the case where the overhead power line voltage is 750V. The parallel-connected second series circuit comprising the third DC/DC converter 8c and fourth DC/DC converter 8d is provided in view of the risk that capacity might be insufficient with only the first series circuit comprising the first DC/DC converter 8a and second DC/DC converter 8b.

In the vehicle power source device constructed in this way, the input sides of the unit DC/DC converters 8 with respect to the power from the overhead power line are assumed to be series-connected, so there is no need for the switching elements 9 (9a, 9b, 9c, 9d) of the unit DC/DC converters 8 to have a high voltage withstanding ability capable of coping with the voltage of the overhead power line: elements of low voltage withstanding ability and low switching loss can thus be employed. A vehicle power source device according to this embodiment can therefore make it possible to achieve reduced loss.

Also, since, in a vehicle power source device according to this embodiment, a vehicle power source device can be created having any desired device capacity or output voltage, by a combination of unit DC/DC converters 8 device taking into account problems such as inductive heating, in addition to reduced loss, reduced costs can also be achieved. Furthermore, since it is possible to employ a high frequency insulating transformer 6 instead of the low-frequency insulating transformer 3, the vehicle power source device of this embodiment can also achieve size reduction.

Thus, with a vehicle power source device constructed in this way, reduced costs, reduced loss and reduced size can be achieved.

It should be noted that, by adopting a construction in which the output sides of the first DC/DC converter 8a to the fourth DC/DC converter 8d are connected in parallel, the same benefits can be obtained by employing the required device capacity and output voltage, as shown in FIG. 8. The vehicle power source device can also be further reduced in size by constructing the inverter 5, high frequency insulating transformer 6 and rectifier 7 of the DC/DC converter 8 on a printed circuit board as shown in FIG. 9.

### Fourth Embodiment

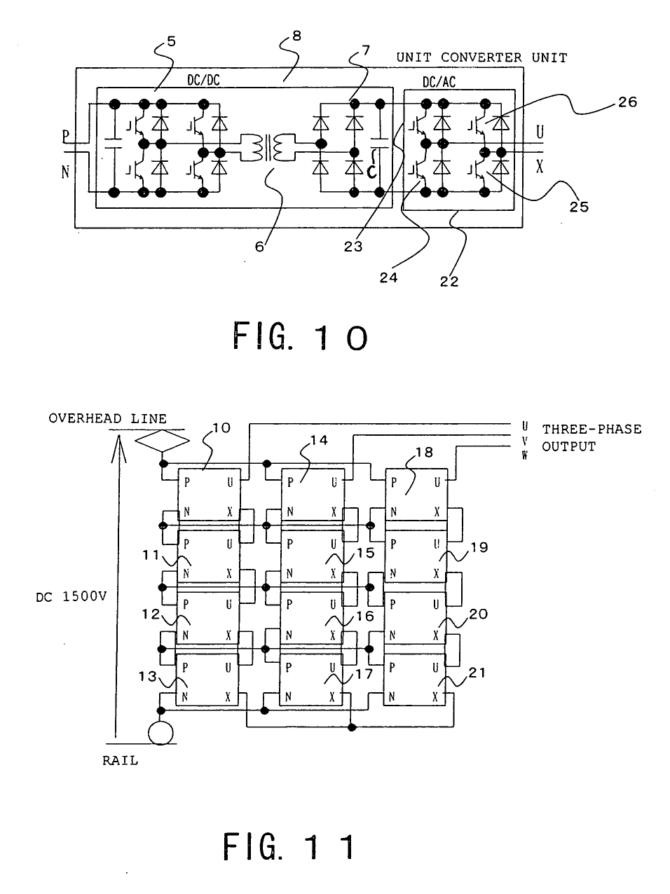

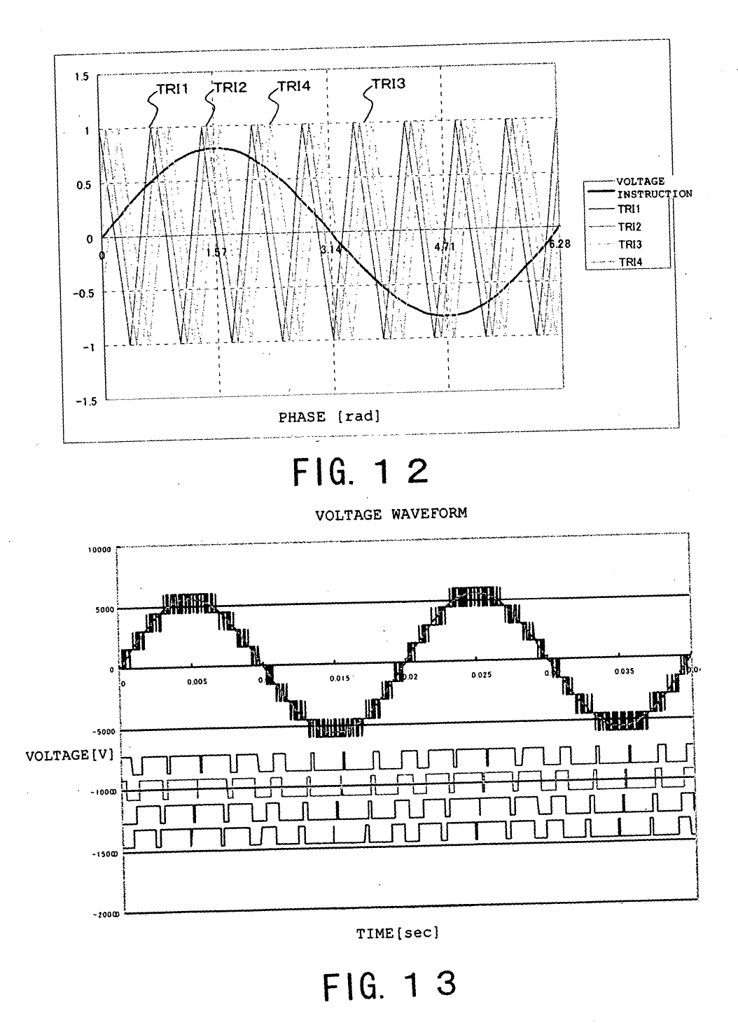

A vehicle power source device according to a fourth embodiment of the present invention is described in detail with reference to the drawings. FIG. 10 is a layout diagram of a unit converter unit of a vehicle power source device according to a fourth embodiment of the present invention. FIG. 11 is a layout diagram of a vehicle power source device according to the fourth embodiment of the present invention. FIG. 12 is a diagram of the phase difference operation in a vehicle power source device according to the fourth embodiment of the present invention. FIG. 13 is a diagram of the combined output voltage waveform in phase difference operation of a vehicle power source device according to the fourth embodiment of the present invention. Parts which are the same in construction as those shown in FIG. 2 to FIG. 9 are given the same reference symbols and further description thereof is omitted.

One of the characteristic features of the vehicle power source device according to the fourth embodiment of the present invention is that a further reduction in size compared with the vehicle power source devices according to the first to third embodiments is achieved by providing a low-distortion AC voltage output unit (means) in place of the LC filter 2 employed in the vehicle power source devices according to the first to third embodiments.

The vehicle power source device according to the fourth embodiment of the present invention comprises 12 unit converters, namely, unit converter 10 to unit converter 21. The unit converter 10 to the unit converter 21 comprises a unit DC/DC converter 8 and DC/AC inverter 22.

In the vehicle power source device constructed in this way, as shown in FIG. 11, the DC voltage that is picked up from the overhead power line through the pantograph mounted on the vehicle is divided into four equal parts that are input as the inputs to the unit converter 10, unit converter 11, unit converter 12 and unit converter 13, which are series-connected. Specifically, a construction is adopted in which the positive input Pin1 of the unit converter 10 is connected with the pantograph; connection is effected from the negative input Nin1 of the unit converter 10 to the positive input Pin2 of the unit converter 11; connection is effected from the negative input Nin2 of the unit converter 11 to the positive input Pin3 of the unit converter 12; connection is effected from the negative input Nin3 of the unit converter 12 to the positive input Pin4 of the unit converter 13; and the negative input Nin4 of the unit converter 13 is connected with a vehicle wheel that is connected with the negative side of the overhead power source.

Likewise the unit converters 14 to 17 and the unit converters 18 to 21 are respectively series-connected and the DC voltage that is picked up from the overhead power line is equally divided into four before being input thereto.

Specifically, a construction is adopted in which the positive input Pin5 of the unit converter 14 is connected with the pantograph; connection is effected from the negative input Nin5 of the unit converter 14 to the positive input Pin6 of the unit converter 15; connection is effected from the negative input Nin6 of the unit converter 15 to the positive input Pin7 of the unit converter 16; connection is effected from the negative input Nin7 of the unit converter 16 to the positive input Pin8 of the unit converter 17; and the negative input Nin8 of the unit converter 17 is connected with a vehicle wheel that is connected with the negative side of the overhead power source. And a construction is adopted in which the positive input Pin9 of the unit converter 18 is connected with the pantograph; connection is effected from the negative input Nin9 of the unit converter 18 to the positive input Pin1O of the unit converter 19; connection is effected from the negative input Nin1O of the unit converter 19 to the positive input Pin11 of the unit converter 20; connection is effected from the negative input Nin11 of the unit converter 20 to the positive input Pin12 of the unit converter 21; and the negative input Nin12 of the unit converter 21 is connected with a vehicle wheel that is connected with the negative side of the overhead power source.

The output stages of the unit converters 10 to 13 are series-connected and output U phase voltage of 60 Hz; the output stages of the unit converters 14 to 17 are likewise series-connected and output V phase voltage that is offset in phase by 120° from the U phase voltage; and the unit converters 18 to 21 are likewise series-connected at their output stages and output W phase voltage, that is offset in phase by 240° with respect to the U phase voltage.

In a vehicle power source device constructed in this way, the DC/AC converter unit 22 is constituted by IGBT elements IGBT 23 to 26 (an IGBT is a type of semiconductor switching element) and a DC capacitor C. When DC voltage is input, 60 Hz AC voltage is output by the switching action of the IGBTs 23 to 26. For the switching, ordinary triangular wave comparison PWM using the results of a triangular wave magnitude comparison with the respective UVW phase voltage instructions is employed.

As shown in FIG. 12, the triangular waves are set at frequencies of 2 kHz so as to produce a switching frequency of 2 kHz; the triangular wave TRIL of the DC/AC inverter constituting the unit converter 10, the triangular wave TRI2 of the DC/AC inverter constituting the unit converter 11, the triangular wave TRI3 of the DC/AC inverter constituting the unit converter 12 and the triangular wave TRI4 of the DC/AC inverter of the unit converter 13 are set with phase differences of 22.5° in each case, as shown in FIG. 12. By thus offsetting the switching timings of the output voltage pulses of the unit converters 2, a multi-level voltage waveform with little distortion can be obtained with a combined voltage as shown in FIG. 13. The triangular waves of the unit converters 14 to 17 and 18 to 21 are set with the same phase difference.

With a vehicle power source device constructed in this way, it is possible to eliminate the AC LC filter at the output stage, so a further reduction in size can be achieved compared with the vehicle power source devices of the first to the third embodiments.

Thus, with a vehicle power source device constructed in this way, reduced costs, reduced loss and reduced size can be achieved.

### Fifth Embodiment

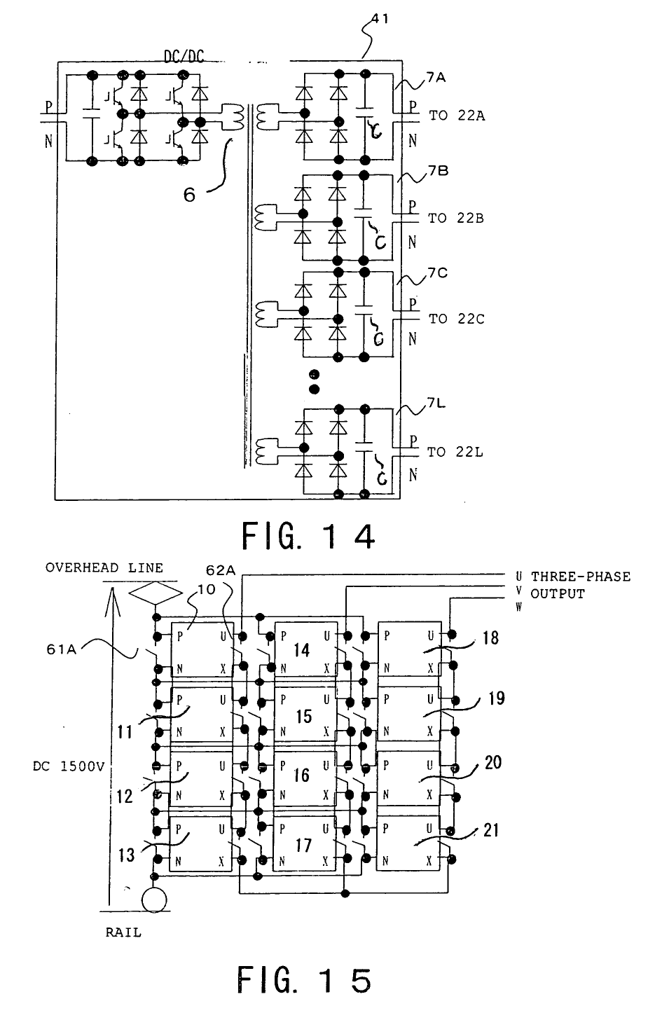

A vehicle power source device according to a fifth embodiment of the present invention is described in detail with reference to the drawings. FIG. 14 is a layout diagram of a unit DC/DC converter of a vehicle power source device according to the fifth embodiment of the present invention. Parts which are the same in construction as those shown in FIG. 2 to FIG. 13 are given the same reference symbols and further description thereof is omitted.

The vehicle power source device according to the fifth embodiment of the present invention comprises a single-input 12-output unit DC/DC converter 41 and twelve DC/AC inverters 51A to 51L (not shown).

The unit DC/DC converter 41 converts the part of the overhead power line to square-wave AC of 50 kHz by using the inverter 6 and inputs this to 12 rectifiers 7A, 7B to 7K, 7L through a high frequency transformer. The 12 rectifiers 7A, 7B to 7K and 7L output DC voltage smoothed by respective filter capacitors. The 12 insulated DC voltages that are output by the 12 rectifiers 7 are output to the DC/AC inverters 51A to 51L. The DC/AC inverters 51A to 51L perform the same action as the DC/AC inverter unit 22 in the fourth embodiment and output UVW three-phase 60 Hz voltage.

The DC/AC inverters 51A, 51B, 51C, 51D have their respective output stages connected in series and can produce a multi-level voltage waveform with little distortion by mutual triangular wave phase difference operation. The triangular waves of the DC/AC inverters 51E to 51H and 51I to 51L are set with the same phase difference. In this way, the output stage AC LC filters can be eliminated.

With a vehicle power source device constructed in this way, the elimination of the AC LC filter at the output stage makes it possible to achieve a further reduction in size compared with the vehicle power source devices of the first to the third embodiments.

Also, with a vehicle power source device constructed in this way, reduced costs, reduced loss and reduced size can be achieved.

### Sixth Embodiment

A vehicle power source device according to a sixth embodiment of the present invention is described in detail with reference to the drawings. FIG. 15 is a layout diagram of a vehicle power source device according to the sixth embodiment of the present invention. Parts which are the same in construction as those shown in FIG. 2 to FIG. 14 are given the same reference symbols and further description thereof is omitted.

The characteristic feature of the vehicle power source device according to the sixth embodiment of the present invention is that, in addition to the structural elements of the fourth embodiment, there are provided switches 61 (61A, 61B, 61C, 61D; however, no reference numerals are attached in the case of 61B to 61D, to simplify the drawings) and 62 (62A, 62B, 62C, 62D; however, no reference symbols are attached in the case of 62B to 62D, to simplify the drawings) that can be respectively electrically short-circuited, at the input side and output side of the unit converters 10 to 21.

For example, if for some reason the unit converter 10 becomes inoperable, the input short-circuit switch 61A and the output short-circuit switch 62A of the unit converter 10 are respectively switched on to produce a short-circuited condition and operation is then continued with the other unit converters 11, 12 to 21. In this way, continuity of operation of the system can be improved and redundancy improved.

With a vehicle power source device constructed in this way, the elimination of the AC LC filter at the output stage makes it possible to achieve a further reduction in size compared with the vehicle power source devices of the first to the third embodiments.

Also, with a vehicle power source device constructed in this way, reduced costs, reduced loss and reduced size can be achieved.

### Seventh Embodiment

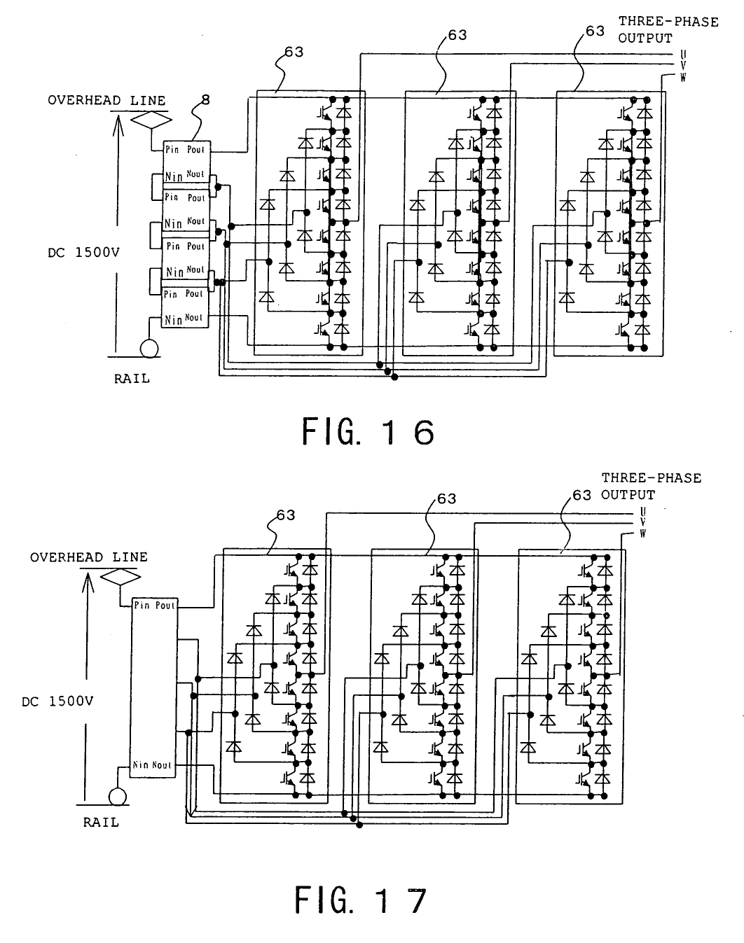

A vehicle power source device according to a seventh embodiment of the present invention is described in detail with reference to the drawings. FIG. 16 is a layout diagram of a vehicle power source device according to the seventh embodiment of the present invention. FIG. 17 is a modified example of the seventh embodiment of the present invention. Parts which are the same in construction as those shown in FIG. 2 to FIG. 15 are given the same reference symbols and further description thereof is omitted.

The vehicle power source device according to the seventh embodiment of the present invention comprises DC/DC converters 8 (8a to 8d) and a 3-phase 5-level inverter 63 (multi-level inverter).

The inputs of the DC/DC converters 8a to 8d are mutually connected in series and are fed with DC voltage from the overhead power line. Likewise, the outputs are also mutually connected in series, each of the junction points being connected with the DC input of the 5-level inverter 63.

The 5-level inverter 63 is a previously known clamping type 5-level inverter and its switching action is also previously known and so will not be described herein. With this construction, insulation between the overhead power line and the output is achieved and AC output voltage with little waveform distortion can be obtained even without using an LC filter.

With a vehicle power source device constructed in this way, the elimination of the AC LC filter at the output stage makes it possible to achieve a further reduction in size compared with the vehicle power source devices of the first to the third embodiments.

Also, with a vehicle power source device constructed in this way, reduced costs, reduced loss and reduced size can be achieved.

In a modified example of the vehicle power source device according to this embodiment, as shown in FIG. 17, a construction may also be envisioned in which reduced costs, reduced loss and reduced size of the power source device are achieved by providing a single DC/DC converter.

In the description of the vehicle power source devices according to the first to the seventh embodiments of the present invention, the semiconductor elements mounted in the converter 5 were described by way of example as IGBTs, but the semiconductor elements mounted in a vehicle power source device according to present invention are of course not restricted to being IGBTs.

As described above, with this invention, a vehicle power source device can be provided whereby reduced size can be achieved.

1. A vehicle power source device comprising:
an inverter that converts a DC power to a high frequency AC power;
a high frequency insulating transformer whereby said AC power that is supplied from said inverter is electrically insulated;
a plurality of unit DC/DC converters of miniature unitary construction whose unit modules are rectifiers that convert a high frequency AC power supplied from said high frequency transformer to a DC power; and
a CVCF inverter that converts said DC power supplied from said plurality of DC/DC converters to an AC power,
wherein input sides of said plurality of unit DC/DC converters are connected in series and output sides of said plurality of unit DC/DC converters are series or parallel or series/parallel connected.

2. The vehicle power source device according to claim 1, wherein in said unit DC/DC converters, at least semiconductor elements constituting said inverter and said rectifiers and a high frequency wiring of said DC/DC converters are mounted on a printed circuit board.

3. The vehicle power source device comprising:
a plurality of unit DC/DC converters having a high frequency insulating transformer and that convert an AC power from an overhead power line to a DC power; and
a CVCF inverter that converts said DC power supplied from said unit DC/DC converters to an AC power.

4. The vehicle power source device comprising:
a DC/DC converter having a high frequency insulating transformer and that converts a power from an overhead power line to a DC power; and
a CVCF inverter that converts a DC power supplied from said DC/DC converter to an AC power.

5. The vehicle power source device according to any of claim 1 to claim 4, comprising a multi-level inverter instead of said CVCF inverter.

6. The vehicle power source device according to any of claim 1, 3 or 4,
wherein said high-frequency insulating transformer is employed at 50 kHz.

7. A vehicle power source device comprising:
an inverter that converts a DC power to a high frequency AC power;
a high frequency transformer whereby said AC power that is supplied from said inverter is electrically insulated;
a unit DC/DC converter of miniature unitary construction whose unit module is a rectifier that converts a high frequency AC power supplied from said high frequency transformer to a DC power;
a DC/AC converter that converts said DC power supplied from said plurality of unit DC/DC converters to an AC power; and
a plurality of unit converter units of unitary construction whose unit modules are said one unit DC/DC converter and said DC/AC converter,
wherein outputs of said plurality of unit converter units are connected in series and said plurality of unit converter units perform phase difference operation.

8. The vehicle power source device according to claim 7,
wherein said unit DC/DC converter is multi-output.

9. The vehicle power source device according to claim 8,
wherein a switch is provided on an input side of said unit converter unit.
